(19) United States
(12) Patent Application Publication
(10) Pub. No.: US 2006/0190474 A1
(43) Pub. Date: Aug. 24, 2006

(54) Extensible markup language schema for mathematical expressions

(75) Inventors: Jennifer P. Michelstein, Kirkland, WA (US); Said Abou-Hallawa, Redmond, WA (US); Ethan Joseph Bernstein, Seattle, WA (US); Robert A. Little, Redmond, WA (US); Murray Sargent III, Medina, WA (US); JASON RAJTAR, REDMOND, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/067,540

(22) Filed: Feb. 22, 2005

(51) Int. Cl. G06F 17/00

(52) U.S. Cl. 707/102

(57) ABSTRACT

An extensible markup language-based schema for representing a mathematical expression in documents. The schema can include a single math tag indicative of text and operators of the mathematical expression. The schema can also include format attributes indicative of one of a plurality of formats to be applied to the mathematical expression.

### RELATED APPLICATION(S)

U.S. patent application Ser. No. 10/943,095, filed on Sep. 15, 2004 and entitled “Systems and Methods for Automated Equation Buildup,” and U.S. patent application Ser. No. ______, Attorney Docket No. 310645.01/14917.57US01, filed on even date herewith and entitled “Programmable Object Model for Mathematical Expressions,” are hereby incorporated by reference.

### REFERENCE TO A COMPUTER PROGRAM LISTING APPENDIX

Two identical Compact Disc-Recordables (CD-Rs) labeled “Copy 1” and “Copy 2” are provided at the Appendix of this patent document. Each CD-R is formatted in IBM-PC format and is compatible with the MS-Windows operating system. Each CD-R includes one file entitled “xm1-310646.1-14917.58US01.xsd,” which is 12.1 kilobytes in size and has a creation date of Feb. 16, 2005. The file on each CD-R is accessible using an XML-based or text-based editor.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

Embodiments of the present invention relate to an extensible markup language schema for mathematical expressions.

### BACKGROUND

The ability to efficiently input and save mathematical expressions in word processing applications and html editors is becoming increasingly important as more technical information is distributed in word-processed and web page formats. Different formats are available to represent mathematical expressions in documents, such as TeX and LaTeX.

One example format that is used for mathematical notation is Mathematical Markup Language (MathML) Version 2.0 (Second Edition), dated Feb. 21, 2001, from the World Wide Web Consortium (W3C) Math working group. MathML is an Extensible Markup Language (XML) notation that is used to represent mathematical expressions.

XML is a universal language that provides a way to identify, exchange, and process various kinds of data. For example, XML is used to create documents that can be utilized by a variety of application programs. Elements of an XML file typically have an associated namespace and schema. A namespace is a unique identifier for a collection of names that are used in XML documents to define element/attribute names and types. The name of a namespace is commonly used to uniquely identify each class of XML document. XML Schemata (schema) provide a way to describe and validate data in an XML environment. A schema states what elements and attributes are used to describe content in an XML document, where each element is allowed, what types of content is allowed within it and which elements can appear within which other elements. The use of schemata ensures that the document is structured in a consistent and predictable manner.

XML-based notations such as MathML are suited for representing mathematical expressions in documents and for web browsers on the Internet. However, using MathML to express mathematical expressions can be disadvantageous in some respects. For example, MathML can be inefficient in that multiple XML tags are required to differentiate between various components of mathematical expressions such as text and operators. In addition, the formatting options for mathematical expressions are limited.

It is therefore desirable to provide an extensible markup language schema for mathematical expressions with greater flexibility and/or efficiency.

### SUMMARY

Embodiments of the present invention relate to an extensible markup language schema for mathematical expressions.

One aspect of the invention relates to a computer-readable medium having an extensible markup language data structure stored thereon for representing a mathematical expression, the data structure including a single math tag indicative of text and operators of the mathematical expression.

Another aspect of the invention relates to a computer-readable medium having an extensible markup language data structure stored thereon for representing a mathematical expression, the data structure including a format attribute indicative of a plurality of formats to be applied to the text of the mathematical expression.

Yet another aspect of the invention relates to an extensible markup language data structure for representing a mathematical expression, the data structure including a single math tag indicative of text and operators of the mathematical expression.

### BRIEF DESCRIPTION OF THE DRAWINGS

Reference will now be made to the accompanying drawings, which are not necessarily drawn to scale, and wherein:

FIG. 1 illustrates an example general purpose computing system; and

FIG. 2 illustrates an application used to create a document including an embedded mathematical expression.

### DETAILED DESCRIPTION

Embodiments of the present invention will now be described more fully hereinafter with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the present invention relate to an extensible markup language schema for mathematical expressions.

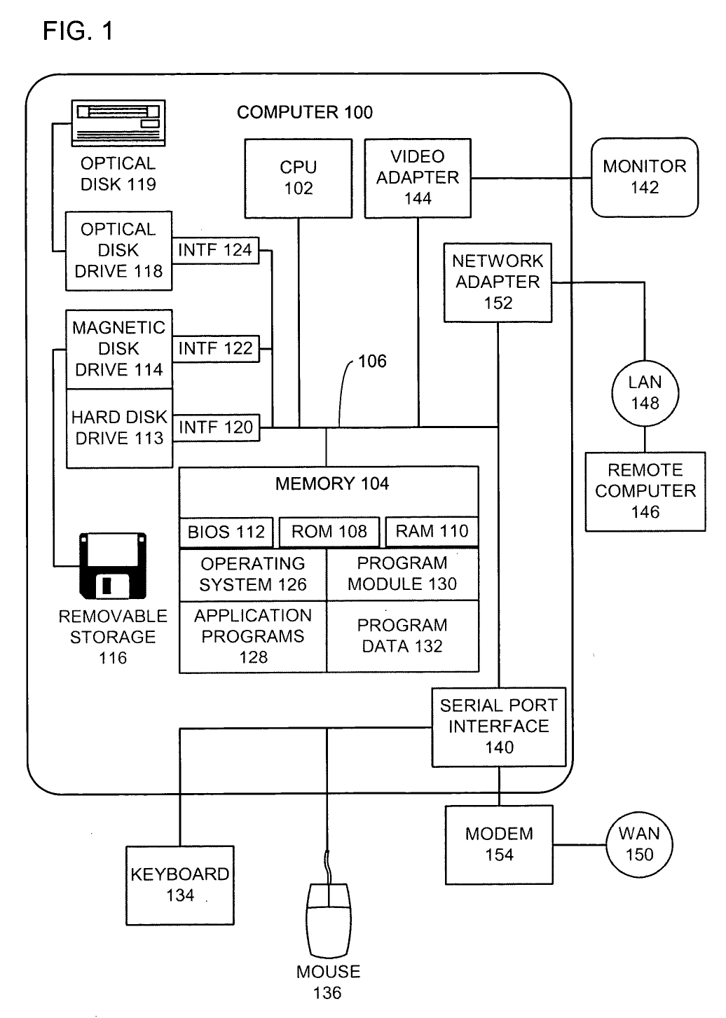

Referring now to FIG. 1, an example computer system 100 is illustrated. The computer system 100 illustrated in FIG. 1 can take a variety of forms such as, for example, a desktop computer, a laptop computer, and a hand-held computer. In addition, although computer system 100 is illustrated, the systems and methods disclosed herein can be implemented in various alternative computer systems as well.

The system 100 includes a processor unit 102, a system memory 104, and a system bus 106 that couples various system components including the system memory 104 to the processor unit 102. The system bus 106 can be any of several types of bus structures including a memory bus, a peripheral bus and a local bus using any of a variety of bus architectures. The system memory includes read only memory (ROM) 108 and random access memory (RAM) 110. A basic input/output system 112 (BIOS), which contains basic routines that help transfer information between elements within the computer system 100, is stored in ROM 108.

The computer system 100 further includes a hard disk drive 113 for reading from and writing to a hard disk, a magnetic disk drive 114 for reading from or writing to a removable magnetic disk 116, and an optical disk drive 118 for reading from or writing to a removable optical disk 119 such as a CD ROM, DVD, or other optical media. The hard disk drive 113, magnetic disk drive 114, and optical disk drive 118 are connected to the system bus 106 by a hard disk drive interface 120, a magnetic disk drive interface 122, and an optical drive interface 124, respectively. The drives and their associated computer-readable media provide nonvolatile storage of computer readable instructions, data structures, programs, and other data for the computer system 100.

Although the example environment described herein can employ a hard disk 113, a removable magnetic disk 116, and a removable optical disk 119, other types of computer-readable media capable of storing data can be used in the example system 100. Examples of these other types of computer-readable mediums that can be used in the example operating environment include magnetic cassettes, flash memory cards, digital video disks, Bernoulli cartridges, random access memories (RAMs), and read only memories (ROMs).

A number of program modules can be stored on the hard disk 113, magnetic disk 116, optical disk 119, ROM 108, or RAM 110, including an operating system 126, one or more application programs 128, other program modules 130, and program data 132.

A user may enter commands and information into the computer system 100 through input devices such as, for example, a keyboard 134, mouse 136, or other pointing device. Examples of other input devices include a toolbar, menu, touch screen, microphone, joystick, game pad, pen, satellite dish, and scanner. These and other input devices are often connected to the processing unit 102 through a serial port interface 140 that is coupled to the system bus 106. Nevertheless, these input devices also may be connected by other interfaces, such as a parallel port, game port, or a universal serial bus (USB). An LCD display 142 or other type of display device is also connected to the system bus 106 via an interface, such as a video adapter 144. In addition to the display 142, computer systems can typically include other peripheral output devices (not shown), such as speakers and printers.

The computer system 100 may operate in a networked environment using logical connections to one or more remote computers, such as a remote computer 146. The remote computer 146 may be a computer system, a server, a router, a network PC, a peer device or other common network node, and typically includes many or all of the elements described above relative to the computer system 100. The network connections include a local area network (LAN) 148 and a wide area network (WAN) 150. Such networking environments are commonplace in offices, enterprise-wide computer networks, intranets, and the Internet.

When used in a LAN networking environment, the computer system 100 is connected to the local network 148 through a network interface or adapter 152. When used in a WAN networking environment, the computer system 100 typically includes a modem 154 or other means for establishing communications over the wide area network 150, such as the Internet. The modem 154, which can be internal or external, is connected to the system bus 106 via the serial port interface 140. In a networked environment, program modules depicted relative to the computer system 100, or portions thereof, may be stored in the remote memory storage device. It will be appreciated that the network connections shown are examples and other means of establishing a communications link between the computers may be used.

The embodiments described herein can be implemented as logical operations in a computing system. The logical operations can be implemented (1) as a sequence of computer implemented steps or program modules running on a computer system and (2) as interconnected logic or hardware modules running within the computing system. This implementation is a matter of choice dependent on the performance requirements of the specific computing system. Accordingly, the logical operations making up the embodiments described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto. This software, firmware, or similar sequence of computer instructions may be encoded and stored upon computer readable storage medium and may also be encoded within a carrier-wave signal for transmission between computing devices.

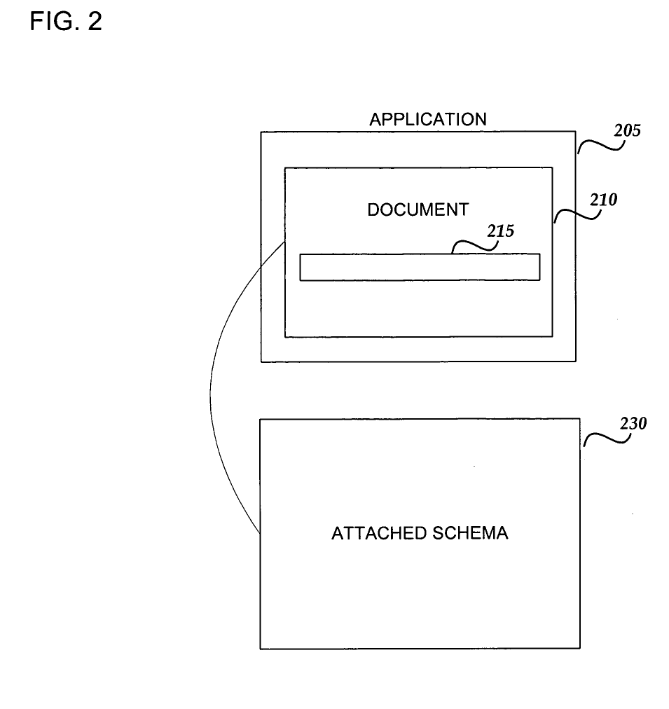

Referring now to FIG. 2, an example block diagram is provided illustrating a document 210 created using an application program 205 (similar to application programs 128 described above). For example, application 205 can be a word processing application such as MICROSOFT Word from MICROSOFT Corporation of Redmond, Wash. Embedded in the document 210 is a mathematical expression 215. In the illustrated example, the mathematical expression 215 is stored in document 210 in an extensible markup language (XML) format. Attached to the document 210 is a schema file 230 defining the construct for the XML format.

In one example, a user inputs the mathematical expression 215 in document 210 using application 205. The user can input the mathematical expression 215 using a format such as the linear format disclosed in U.S. patent application Ser. No. 10/943,095, filed on Sep. 15, 2004 and entitled “Systems and Methods for Automated Equation Buildup.” The mathematic expression 215 can be automatically built-up so that the expression is shown in a two-dimensional format to the user, and the mathematical expression 215 can be saved in document 210 in accordance with the example XML-based notation for mathematical expressions disclosed herein.

In some embodiments, an object-oriented programming model is provided to allow for access to the mathematical expression 215 in document 210 via a set of application programming interfaces or object-oriented message calls either directly through one or more application programming interfaces or programmatically through other software application programs written according to a variety of programming languages such as, for example C, C++, C#, Visual Basic, and the like. In one example, the object-oriented programming model is configured according to that disclosed in U.S. patent application Ser. No. ______, Attorney Docket No. 310645.01/14917.57US01, filed on even date herewith and entitled “Programmable Object Model for Mathematical Expressions.”

The following is a description of an example schema associated with the XML notation for mathematical expressions.

oMath

This is the parent of all of the elements described below. It represents one or more mathematical expressions.

Attributes:
type: disp (default), inl—Equations can be displayed in two-dimensional (e.g., Polish prefix) format (Display) or inline (Inline). If an equation is Display, the only text contained in the paragraph is math text. If the equation is Inline, it is in a paragraph that includes math text and text outside of the math region.
style: disp (default), inl—Equations have a different style based on whether they are Display or Inline. For example, Display equations have taller n-ary operators, and fractions are generally taller than they are if Inline. By default, Display equations have display style and inline equations have inline style. However, the user can override this property, and the style attribute stores this.

Arguments:
Arg: oMath can include any one or more of the following objects as arguments of type oMath.

oMathPr—Properties
This tag is used for properties that are attached to oMath. Any element can have a Pr child element to contain its attributes. For example, the type and display attributes described above reside herein.

r—Math Runs
This tag is used for all text including math text and non-math text.
Format attributes of math runs can include various formatting that can be associated with text. Formatting associated with the document in which the math text and non-math text are embedded can also be associated with the math text and non-math text. Example formatting includes: font type, bold, italics, underlining, color, size, strikethrough, super- and subscript, scale, spacing, shadow, outline, emboss, engrave, and effects such as blinking. Other format attributes can also be included such as footnotes and endnotes.
In addition, math runs can optionally include one or more attributes that can be used to mark certain characters. For example, math runs can optionally include an attribute “nd” (no display), in m:rPr. If a character or run is marked as “nd,” then it does not display when the construct is built-up. In the example, only certain characters can be marked as “nd,” and the “nd” attribute is used to attach extra information to those characters in the run.

t—Math Text
This tag is used for all math text (e.g., symbols and arbitrary text). This tag is also used for all operators.
attributes: n (non-math text), off by default—To have non-math text in a mathematical expression, this attribute is turned on: <m:n val=“on”>. When n is on, all math formatting (math italic, etc) is turned off and text is non-math.
arguments: none

example (inline): Rate=Distance/Time

<m:oMath>

<m:oMathPr>

<m:type val=“inl”/>

</m:oMathPr>
<m:r>

<m:rPr>

<m:n val=“on” />

</m:rPr>
<m:t>Rate</m:t>

</m:r>
<m:r>

<m:t>=</m:t>

</m:r>
<m:f>

<m:num>

<m:r>

<m:rPr>

<m:i val=“off” />

</m:rPr>
<m:t>Distance</m:t>

</m:r>

</m:num>
<m:den>

<m:r>

<m:rPr>

<m:i val=“off” />

</m:rPr>
<m:t>Time</m:t>

</m:r>

</m:num>

</m:f>

</m:oMath>

example: a+b (formatted in the color red)

(Note: The tags w:r, w:rPr, and w:color are associated with the XML schema for the document in which the mathematical expression is embedded. Illustrative schemas for such documents are described in U.S. patent application Ser. No. 10/184,560, filed Oct. 14, 2004 and entitled “System and Method for Supporting Non-native XML in Native XML of a Word-Processor Document,” and U.S. patent application Ser. No. 10/187,060, filed Jun. 28, 2002 and entitled “Word-Processing Document Stored in a Single XML File that may be Manipulated by Applications that Understand XML,” the entireties of which are herein incorporated by reference. The tags associated with a document can be used in conjunction with the schema for the mathematical expressions to attribute a plurality of formats to the mathematical expressions.)

<m:oMath>

<m:r>

<w:r>

<w:rPr>

<w:color w:val=“FF0000” />

</w:rPr>
<m:t>a+b</m:t>

</w:r>

</m:r>

</m:oMath>

example: a=b+c, where a represents distance.

<m:oMath>

<m:r>

<m:t>a=b+c</m:t>

</m:r>
<m:r>

<m:rPr>

<m:n val=“on” >

</m:rPr>
<m:t>, where </m:t>

</m:r>
<m:r>

<m:t>a</m:t>

</m:r>
<m:r>

<m:rPr>

<m:n val=“on” >

</m:rPr>
<m:t> represents distance.</m:t>

</m:r>

</m:oMath>

acc—Accent
attributes: chr (combining mark)—takes any char, default is the accent mark (′) in a′
arguments: e (base)

example: ã

<m:oMath>

<m:acc>

<m:accPr>

<m:chr val=“˜” />

</m:accPr>
<m:e>

<m:r>

<m:t>a</m:t>

</m:r>

</m:e>

</m:acc>

</m:oMath>

sSub—Subscript
attributes: none
arguments:
   e (base)
   sub (subscript)

example: a_{bc}

<m:oMath>

<m:sSub>

<m:e>

<m:r>

<m:t>a</m:t>

</m:r>

</m:e>
<m:sub>

<m:r>

<m:t>bc</m:t>

</m:r>

</m:sub>

</m:sSub>

</m:oMath>

sSup—Superscript
attributes: none
arguments:
   e (base)
   sup (superscript)

example: a^{bc}

<m:oMath>

<m:sSup>

<m:e>

<m:r>

<m:t>a</m:t>

</m:r>

</m:e>
<m:sup>

<m:r>

<m:t>bc</m:t>

</m:r>

</m:sup>

</m:sSup>

</m:oMath>

sSubSup—SubSuperscript
attributes: none
arguments:
   e (base)
   sub (subscript)
   sup (superscript)

example: a_{b}^{c}

<m:oMath>

<m:sSubSup>

<m:e>

<m:r>

<m:t>a</m:t>

</m:r>

</m:e>
<m:sub>

<m:r>

<m:t>b</m:t>

</m:r>

</m:sub>
<m:sup>

<m:r>

<m:t>c</m:t>

</m:r>

</m:sup>

</m:sSubSup>

</m:oMath>

sPre—LeftSubSuperscript
attributes: none
arguments:
   e (base)
   sub (subscript)
   sup (superscript)

example: _{b}^{c}a

<m:oMath>

<m:sPre>

<m:sub>

<m:r>

<m:t>b</m:t>

</m:r>

</m:sub>
<m:sup>

<m:r>

<m:t>c</m:t>

</m:r>

</m:sup>
<m:e>

<m:r>

<m:t>a</m:t>

</m:r>

</m:e>

</m:sPre>

</m:oMath>

limUpp—This is the structure that has small text above a base. It can be used for constructs such as, for example, “the limit of n, as n approaches infinity.”
   attributes: none
   arguments:
      e (base)
      lim (text above)

example:

$${a}^{b c}$$

<m:oMath>

<m:limUpp>

<m:e>

<m:r>

<m:t>a</m:t>

</m:r>

</m:e>
<m:lim>

<m:r>

<m:t>bc</m:t>

</m:r>

</m:lim>

</m:limUpp>

</m:oMath>

limLow—This is the structure that has small text below a base. It can be used for constructs such as, for example, “the limit of n, as n approaches infinity.”
   attributes: none
   arguments:
      e (base)
      lim (text below)

example:

$${a}_{b c}$$

<m:oMath>

<m:limLow>

<m:e>

<m:r>

<m:t>a</m:t>

</m:r>

</m:e>
<m:lim>

<m:r>

<m:t>bc</m:t>

</m:r>

</m:lim>

</m:limLow>

</m:oMath>

groupChr—This is the construct that includes a base and a character that stretches either above or below the base. It can be used for constructs such as, for example, a brace [symbol] positioned above or below one or more characters.
   attributes:
      chr (grouping character): default is [symbol]
      pos (grouping character position): top, bot (bottom—default)
   arguments:
      e (base)

example:

[symbol]

<m:oMath>

<m:groupChr>

<m:groupChrPr>

<m:pos val=“top” />

</m:groupChrPr>
<m:e>

<m:r>

<m:t>abc</m:t>

</m:r>

</m:e>

</m:groupChr>

</m:oMath>

f—Fraction
attributes:
   type: bar (default), skw (skewed), lin (linear), noBar (no-bar)
   baseJc (base alignment): center (default), top, bot
   numJc (numerator alignment): center (default), left, right
   denJc (denominator alignment): center (default), left, right
arguments:
   num (numerator)
   den (denominator)
example:

$$\frac{a + b}{c + d} ,$$

with baseJc=top, numJc=left, and denJc=left

<m:oMath>

<m:f>

<m:fPr>

<m:baseJc val=“top”/>
<m:numJc val=“left”/>
<m:denJc val=“left”/>

</m:fPr>
<m:num>

<m:r>

<m:t>a+b</m:t>

</m:r>

</m:num>
<m:den>

<m:r>

<m:t>c+d</m:t>

</m:r>

</m:den>

</m:f>

</m:oMath>

example:

$$\begin{matrix}a b \\ c d\end{matrix} ,$$

with baseJc=center, numJc=left, and denJc=left

<m:oMath>

<m:f>

<m:fPr>

<m:numJc val=“left”/>
<m:denJc val=“left”/>
<m:type val=“noBar”/>

</m:fPr>
<m:num>

<m:r>

<m:t>ab</m:t>

</m:r>

</m:num>
<m:den>

<m:r>

<m:t>cd</m:t>

</m:r>

</m:den>

</m:f>

</m:oMath>

bar—Bar
attributes:
   pos (position): top (default), bot (bottom)
arguments:
   e (base)

example: \overline{abc}

<m:oMath>

<m:bar>

<m:e>

<m:r>

<m:t>abc</m:t>

</m:r>

</m:e>

</m:bar>

</m:oMath>

example: \overline{abc}

<m:oMath>

<m:bar>
<m:barPr>

<m:pos val=“bot”/>

<m:barPr/>

<m:e>

<m:r>

<m:t>abc</m:t>

</m:r>

</m:e>

</m:bar>

</m:oMath>

rad—Radical
attributes: none
arguments:
   e (radicand)
   deg (degree)—optional

example:

$$\sqrt[3]{144}$$

<m:oMath>

<m:rad>

<m:deg>

<m:r>

<m:t>3</m:t>

</m:r>

</m:deg>
<m:e>

<m:r>

<m:t>144</m:t>

</m:r>

</m:e>

</m:rad>

</m:oMath>

Example: \sqrt{144}

<m:oMath>

<m:rad>

<m:e>

<m:r>

<m:t>144</m:t>

</m:r>

</m:e>

</m:rad>

</m:oMath>

Example:

$$\sqrt[2]{144}$$

<m:oMath>

<m:rad>

<m:deg>

<m:r>

<m:t>2</m:t>

</m:r>

</m:deg>
<m:e>

<m:r>

<m:t>144</m:t>

</m:r>

</m:e>

</m:rad>

</m:oMath>

d—Delimiter—This is the construct that includes open and closed delimiters (including, but not limited to parentheses, brackets, vertical bars, and braces) and their contents.
   attributes:
      begChr (opening character): default=“(”
      endChr (closing character): default=“)”
      grow (grow or match): default=“on”
      sepChr (separator character): default=“|”
      shp (alignment): centered (default), match
   arguments:
      e (delimiter contents)

example: (a+b)

<m:oMath>

<m:d>

<m:e>

<m:r>

<m:t>a+b</m:t>

</m:r>

</m:e>

</m:d>

</m:oMath>

example: [a+b]

<m:oMath>

<m:d>

<m:dPr>

<m:begChr val=“[”/>
<m:endChr val=“]”/>

</m:dPr>
<m:e>

<m:r>

<m:t>a+b</m:t>

</m:r>

</m:e>

</m:d>

</m:oMath>

example: {x<2|y=0}

<m:oMath>

<m:d>

<m:dPr>

<m:begChr val=“{”/>
<m:endChr val=“}”/>

</m:dPr>
<m:e>

<m:r>

<m:t>x<2</m:t>

</m:r>

</m:e>
<m:e>

<m:r>

<m:t>y=0</m:t>

</m:r>

</m:e>

</m:d>

</m:oMath>

example: (y|y<½}

<m:oMath>

<m:d>

<m:dPr>

<m:endChr val=“}”/>

</m:dPr>
<m:e>

<m:r>

<m:t>y</m:t>

</m:r>

</m:e>
<m:e>

<m:r>

<m:t>y<1/2</m:t>

</m:r>

</m:e>

</m:d>

</m:oMath>

example: (x+y|x<1|y>2)

<m:oMath>

<m:d>

<m:e>

<m:r>

<m:t>x+y</m:t>

</m:r>

</m:e>
<m:e>

<m:r>

<m:t>x<1</m:t>

</m:r>

</m:e>
<m:e>

<m:r>

<m:t>y>2</m:t>

</m:r>

</m:e>

</m:d>

</m:oMath>

nary—Nary Operator
attributes:
   chr (nary operator character): default=“∫⁰
   limLoc (limit location): undOvr (default), subSup
   size: match (default), grow
arguments:
   sub (lower limit): optional
   sup (upper limit): optional
   e (base)

example:

$${\int }_{a}^{b} x ⅆ x$$

<m:oMath>

<m:nary>

<m:naryPr>

<m:limLoc val=“subSup”/>

</m:naryPr>
<m:sub>

<m:r>

<m:t>a</m:t>

</m:r>

</m:sub>
<m:sup>

<m:r>

<m:t>b</m:t>

</m:r>

</m:sup>
<m:e>

<m:r>

<m:t>x dx</m:t>

</m:r>

</m:e>

</m:nary>

</m:oMath>

example: Σx

<m:oMath>

<m:nary>

<m:naryPr>

<m:chr val=“Σ”/>

</naryPr>
<m:e>

<m:r>

<m:t>x</m:t>

</m:r>

</m:e>

</m:nary>

</m:oMath>

example:

$${\int }_{a}^{b} x ⅆ x$$

<m:oMath>

<m:nary>

<m:sub>

<m:r>

<m:t>a</m:t>

</m:r>

</m:sub>
<m:sup>

<m:r>

<m:t>b</m:t>

</m:r>

</m:sup>
<m:e>

<m:r>

<m:t>x dx</m:t>

</m:r>

</m:e>

</m:nary>

</m:oMath>

func—Function
attributes: none
arguments:
   e (base)
   fname (function argument—e.g., sin, cos, tan)

example: cos x

<m:oMath>

<m:fName>

<m:name>

<m:r>

<m:t>cos</m:t>

</m:r>

</m:name>
<m:e>

<m:r>

<m:t>x</m:t>

</m:r>

</m:e>

</m:fName>

</m:oMath>

eqArray—This construct includes one or more equations presented in an array. The equations can all appear to be on separate lines, but are actually contained in a single paragraph. Equation arrays can be used for multiple alignment points and for assigning one number to a group of equations.
   attributes: baseJc (base alignment): center (default), topBase, botBase rowJc (row alignment): center (default), base
   arguments:
      e (equation)
         jc (alignment)

example: 1+2=3 and 3+4=7 (as two equations in an eqarray, with the “=” signs aligned)

<m:oMath>

<m:eqArray>

<m:e>

<m:r>

<m:t>1+2</m:t>

</m:r>
<jc>

<m:r>

<m:t>=</m:t>

</m:r>

</jc>
<m:r>

<m:t>3</m:t>

</m:r>

</m:e>
<m:e>

<m:r>

<m:t>3+4</m:t>

</m:r>
<jc>

<m:r>

<m:t>=</m:t>

</m:r>

</jc>
<m:r>

<m:t>7</m:t>

</m:r>

</m:>

</m:eqArray>

</m:oMath>

m—Matrix
attributes:
   mJc (alignment): center (default), top, bot
   mcs (parent of mc)
   mc (column)-mcjc: center (default), left, right; count
   mr (row)-mrjc: center (default), base
arguments:
   mr (row)
   e (cell in specified row)
example

$$\begin{matrix}1 & 2 \\ 3 & 4\end{matrix} ,$$

with columns left-aligned and rows base aligned

<m:oMath>

<m:m>

<m:mPr>

<m:mcs>

<m:mc>

<m:mcPr>

<m:count val=“2”/>
<m:mcJc val=“left”/>

</m:mcPr>

</m:mc>

</m:mcs>

</m:mPr>
<m:mr>

<m: mrPr>

<m:mrJc val=“base”/>

</m: mrPr>
<m:e>

<m:r>

<m:t>1</m:t>

</m:r>

</m:e>
<m:e>

<m:r>

<m:t>2</m:t>

</m:r>

</m:e>

</m:mr>
<m:mr>

<m:mrPr>

<m:mrJc val=“base”/>

</m:mrPr>
<m:e>

<m:r>

<m:t>3</m:t>

</m:r>

</m:e>
<m:e>

<m:r>

<m:t>4</m:t>

</m:r>

</m:e>

</m:mr>

</m:m>

</m:oMath>

Example:

$$\begin{matrix}100 & 200 & 300 \\ 1 & 3 & 5 \\ 2 & 4 & 6\end{matrix} ,$$

all columns and rows center aligned

<m:oMath>

<m:m>

<m:mr>

<m:e>

<m:r>

<m:t>100</m:t>

</m:r>

</m:e>
<m:e>

<m:r>

<m:t>200</m:t>

</m:r>

</m:e>
<m:e>

<m:r>

<m:t>300</m:t>

</m:r>

</m:e>

</m:mr>
<m:mr>

<m:e>

<m:r>

<m:t>1</m:t>

</m:r>

</m:e>
<m:e>

<m:r>

<m:t>3</m:t>

</m:r>

</m:e>
<m:e>

<m:r>

<m:t>5</m:t>

</m:r>

</m:e>

</m:mr>
<m:mr>

<m:e>

<m:r>

<m:t>2</m:t>

</m:r>

</m:e>
<m:e>

<m:r>

<m:t>4</m:t>

</m:r>

</m:e>
<m:e>

<m:r>

<m:t>6</m:t>

</m:r>

</m:e>

</m:mr>

</m:m>

</m:oMath>

box—This construct is a region around a given math range that can be positioned as an individual unit. In addition to the attributes described below, this construct can optionally include one or more additional attributes related to the border of the box.
   attributes:
      fTransp (transparency of the box)
      StyleOver (allows override of style associated with arguments in box)
      fBreakable (whether or not breaking is allowed)
      vertJc (vertical alignment): center (default), base
arguments:
   e (base)

example: a=b+c

<m:oMath>

<m:box>

<m:e>

<m:r>

<m:t>a=b+c</m:t>

</m:r>

</m:e>

</m:box>

</m:oMath>

### EXAMPLES

example:

$$i = \frac{E}{R} {ⅇ}^{- \frac{t}{{τ}_{L}}} = {i}_{0} {ⅇ}^{- \frac{t}{{τ}_{L}}}$$

<m:oMath>

<w:r>

<w:t>i=</w:t>

</w:r>
<m:f>

<m:num>

<w:r>

<w:t>E</w:t>

</w:r>

</m:num>
<m:den>

<w:r>

<w:t>R</w:t>

</w:r>

</m:den>

</m:f>
<m:sSup>

<m:e>

<w:r>

<w:t>e</w:t>

</w:r>

</m:e>
<m:sup>

<m:r>

<m:t>-</m:t>

</m:r>
<m:f>

<m:num>

<w:r>

<w:t>t</w:t>

</w:r>

</m:num>
<m:den>

<m:sSub>

<m:e>

<m:r>

<m:t>τ</m:t>

</m:r>

</m:e>
<m:sub>

<m:r>

<m:t>L</m:t>

</m:r>

</m:sub>

</m:sSub>

</m:den>

</m:f>

</m:sup>

</m:sSup>
<w:r>

<w:t>=</w:t>

</w:r>
<m:sSub>

<m:e>

<w:r>

<w:t>i</w:t>

</w:r>

</m:e>
<m:sub>

<w:r>

<w:t>o</w:t>

</w:r>

</m:sub>

</m:sSub>
<m:sSup>

<m:e>

<w:r>

<w:t>e</w:t>

</w:r>

</m:e>
<m:sup>

<m:r>

<m:t>-</m:t>

</m:r>
<m:f>

<m:num>

<w:r>

<w:t>t</w:t>

</w:r>

</m:num>
<m:den>

<m:sSub>

<m:e>

<m:r>

<m:t>τ</m:t>

</m:r>

</m:e>
<m:sub>

<m:r>

<m:t>L</m:t>

</m:r>

</m:sub>

</m:sSub>

</m:den>

</m:f>

</m:sup>

</m:sSup>

</m:oMath>

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. A computer-readable medium having an extensible markup language data structure stored thereon for representing a mathematical expression, the data structure comprising a single math tag indicative of text and operators of the mathematical expression.

2. The computer-readable medium of claim 1, further comprising a format attribute indicative of one of a plurality of formats to be applied to the mathematical expression.

3. The computer-readable medium of claim 2, wherein the format attribute includes formatting selected from the group consisting of bold, italics, and underlining.

4. The computer-readable medium of claim 2, wherein the format attribute includes footnotes.

5. The computer-readable medium of claim 2, wherein the format attribute includes an attribute for display or inline.

6. The computer-readable medium of claim 1, wherein the data structure further comprises a fraction tag.

7. The computer-readable medium of claim 1, wherein the data structure further comprises a delimiter tag.

8. A computer-readable medium having an extensible markup language data structure stored thereon for representing a mathematical expression, the data structure comprising a format attribute indicative of a plurality of formats to be applied to the text of the mathematical expression.

9. The computer-readable medium of claim 8, wherein the format attribute includes formatting selected from the group consisting of bold, italics, and underlining.

10. The computer-readable medium of claim 8, wherein the format attribute includes footnotes.

11. The computer-readable medium of claim 8, further comprising a single math tag indicative of text and operators of the mathematical expression.

12. The computer-readable medium of claim 8, wherein the data structure further comprises a fraction tag.

13. The computer-readable medium of claim 8, wherein the data structure further comprises a delimiter tag.

14. The computer-readable medium of claim 8, wherein the format attribute includes an attribute for display or inline.

15. An extensible markup language data structure for representing a mathematical expression, the data structure comprising a single math tag indicative of text and operators of the mathematical expression.

16. The data structure of claim 15, further comprising a format attribute indicative of one of a plurality of formats to be applied to the mathematical expression.

17. The data structure of claim 16, wherein the format attribute includes formatting selected from the group consisting of bold, italics, and underlining.

18. The data structure of claim 16, wherein the format attribute includes footnotes.

19. The data structure of claim 15, wherein the data structure further comprises a fraction tag.

20. The data structure of claim 15, wherein the data structure further comprises a delimiter tag.
